(19) United States
(12) Patent Application Publication
(10) Pub. No.: US 2008/0304381 A1
(43) Pub. Date: Dec. 11, 2008

(54) Method and Apparatus for Detecting Cracks in an Optical Record Carrier

(75) Inventor: Pippinus Maarten Robertus Wortelboer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/096,190

(22) PCT Filed: Nov. 16, 2006
(86) PCT No.: PCT/IB2006/054296

§ 371 Date: Jun. 5, 2008

(30) Foreign Application Priority Data
Dec. 8, 2005 (EP) 05111820.6

(51) Int. Cl. G11B 20/18

(52) U.S. Cl. 369/53.2; G9B/20.046

(57) ABSTRACT

The present invention relates to a reading apparatus and to a corresponding reading method for reading data from, and detecting cracks in, an optical record carrier (10). To achieve that a crack in the optical record carrier can be detected with a high reliability so that appropriate measures can be taken, the apparatus comprises a reading unit (14, 15) for reading data from said record carrier by use of a radiation beam and for generating a data signal (RF), a servo error detection unit (16) for tracking a data track on the record carrier and for generating a tracking error signal (TE) and a focus error signal (FE), a control unit (19) for controlling the axial and radial positions of the read-out spot on the record carrier by use of a focus control signal (FA) and a radial control signal (RA), and a crack detection unit (21) for determining whether there is a crack in the record carrier by checking whether the focus error signal (FE) and/or the tracking error signal (TE) show a significant peak, and whether the focus control signal (FA) and/or the radial control signal (RA) show a significant step change.

The present invention relates to an apparatus for, and a corresponding method of, reading data from, and detecting cracks in, an optical record carrier. The present invention further relates to a computer program for implementing said method on, for example, a computer.

Optical record carriers, such as CD, DVD and BD discs, may crack. Cracks may occur in any disc that has been subjected to dynamic and/or static mechanical loads over a longer period of time. Especially inferior quality discs may crack easily. The problems with cracked discs are that they are vulnerable to explosion at higher rotation speeds, and that the data in the information area of a disc cannot be read anymore when cracks are present in this information area. This is because known servo control algorithms cannot cope with sudden large jumps in the radial, the focus, and the circumferential direction. Such large jumps occur in a cracked disc because the data track, along which the data is stored on a disc, is no longer continuous at the position of a crack. Known servo algorithms can only cope with small defects in the information layer of a disc and with moderate defects on the radiation entrance surface of a disc, such as for example black dots, fingerprints or scratches.

US 2005/0052967 A1 discloses a method of, and an apparatus for, preventing an optical record carrier from being fractured due to a crack. The disclosed method and apparatus are used for detecting a first tracking error signal outputted from a data recording/reproducing apparatus when the optical record carrier is rotated at a first speed; detecting a second tracking error signal outputted from the data recording/reproducing apparatus when the same optical record carrier is rotated at a second speed; determining whether or not a crack on the optical record carrier exists on the basis of the first tracking error signal and the second tracking error signal; and stopping an operation of the data recording/reproducing apparatus when the optical record carrier appears to have a crack. The idea behind the method disclosed in US 2005/0052967 A1 is that a crack is detected based on the increased level of a peak in the tracking error signal as the speed of the optical record carrier is increased, since non-crack related disturbances will not exhibit such speed-dependence.

It is an object of the present invention to provide a more robust apparatus and method by means of which a crack in an optical record carrier can be detected with a higher reliability, so that appropriate measures can be taken.

This object is achieved according to a first aspect of the present invention by providing an apparatus comprising

a reading unit for reading data from an optical record carrier by use of a radiation beam, and for generating a data signal,

a servo error detection unit for tracking a data track along which said data are recorded on the optical record carrier, and for generating a tracking error signal and a focus error signal,

a control unit for controlling an axial and a radial position of a read-out spot of said radiation beam on the optical record carrier by use of a focus control signal and a radial control signal, and

a crack detection unit for determining whether there is a crack in the optical record carrier by checking whether said focus error signal and/or said tracking error signal show a significant peak, and whether said focus control signal and/or said radial control signal show a significant step change.

A corresponding method according to a further aspect of the present invention is defined in claim 13. A computer program for implementing a method according to the present invention on a computer, a reading apparatus or any other appropriate device is defined in claim 14. Preferred embodiments of the present invention are defined in the dependent claims.

Although the present invention can be applied for the detection of different types of cracks, in practice, typical sharp cracks appear that can be detected particularly well by the present invention. These sharp cracks have two mirror-like edges, a limited angle with the radius, an orientation of the crack surface that is almost perpendicular to the disc surface, a limited relative displacement and rotation of the crack ends, which are incomplete. It has been found that known servo systems are capable of detecting defects on the substrate's outer surface. However, the defect at the outer surface due to a typical sharp crack is limited. Furthermore, the servo signals (that is, the tracking error signals) can be disturbed by defects on the read-out surface in general, even when the information track is in good condition. A crack definitely causes a defect in the information track, so the data signal will be corrupted. The amount of disturbance caused in the read-out spot by the crack as the light goes through the substrate depends on the sharpness of the crack. A sharp crack will not give much false reflection. If the two opposing crack surfaces have not been displaced too much, the recovery of the track might not be a problem in current drives. When these surfaces have been displaced either in the radial or focus (axial) direction, the normal tracking error signals will show large peaks. When the servo system subsequently finds a track again (which can be the correct track or an incorrect track) the tracking error signals drop to normal values.

The present invention is based on the idea to use the axial and/or the radial control signal (also called focus and radial actuator signal, respectively) in addition to the focus error signal and/or the tracking error signal. These control signals will exhibit a minor effect because the position (in the axial and/or radial direction) of the track changed at a crack. This effect will be largest in the focus (axial) direction, so that preferably the focus error signal and the axial control signal are used for crack detection. In further embodiments, the tracking error signal and the radial control signal are used in addition (to increase the reliability of crack detection), or alternatively, to the focus error signal and the axial control signal.

The invention is based on the observation that cracks, like scratches and black dots, lead to tracking error signals with a clear one-cycle signature, but only cracks will show a sudden (step-like) change in the control signals (actuator signals). Nevertheless, the evaluation of the tracking error signals provides an additional indication of the presence of a crack, and hence increases the reliability of crack detection.

In an embodiment of the invention, it is checked if at least one of the used error signals exhibits an impulse response-like effect (that is, a sudden increase and damped oscillation within a short time, e.g. a few milliseconds) and if at least one of the used control signals has a similar impulse response-like effect and, after a short time (e.g. a few hundred milliseconds), an additional step response-like effect. If these conditions are fulfilled, it is concluded that a crack transition, and not only warpage of the disc or a surface defect, has been detected. It should be noted here that the control signals at the time of crossing a crack are less relevant, since there should not be any tracking when the tracking error signals are excessively high.

According to a preferred embodiment, the levels of the used signals are compared with the levels just before the defect occurs. It is checked whether the amplitude of the focus control signal is indicative of a change of at least +/−5 μm and/or if the amplitude of the tracking error signal is indicative of a change of at least +/−1 μm. When a threshold is exceeded, it is concluded that a crack transition has been found. It is noted that a change of the focus control signal refers to a change proportional to an actuator lens displacement.

When the above thresholds are not exceeded, tracking will not be compromised, and it is preferred that in addition it is checked whether the data signal (also called the HF signal) is still intact or whether it shows interruptions. If it is not intact, either a serious surface defect or an information defect has been detected.

In a preferred embodiment of the invention, the signals used for crack detection are compared to corresponding reference signals previously measured from record carriers having a crack, a scratch and/or no mechanical defects. This comparison of the actually measured signals with reference signals provides an additional indication as to whether a crack, a scratch and/or no mechanical defect is present on a disc.

To further increase the reliability and stability of crack detection, it is advantageous to evaluate the signals used for crack detection over several revolutions (instead of over only one revolution) and/or over neighboring tracks before a decision is taken.

To even further increase the reliability of crack detection, the data (i.e. the HF data) read normally in between the interrupts is preferably used to retrieve address and/or chronological information, such as, for example, ATIP/ADIP information, to compute the number of revolutions of the track skipped at the track recovery, i.e. to determine a so-called track skip number. If this number exceeds a certain level (threshold number), it can be concluded that a crack has been detected.

Furthermore, such track skip number is preferably used to control the axial and radial position of the read-out spot of the irradiation beam just after a crack. In particular, address and/or chronological information is retrieved from the data signal read just before and just after a crack, and it is then checked if the read address and/or chronological information just before and just after the crack is in the right sequential or chronological order.

In an even further preferred embodiment, a feed-forward loop between the control unit and the data processing unit is provided enabling a correction of the axial and radial position of the read-out spot of the radiation beam just after a crack, when the address and/or chronological information just before and just after the crack are not in the right sequential or chronological order, based on the address and/or chronological information retrieved from the data signal read just before and just after the crack. Thus, a kind of learning scheme may be implemented allowing most of the data to be reproduced from a record carrier, despite the presence of a crack, by continuously improving the accuracy of crack detection and the determination of where a track continues after a crack.

After a crack, it is preferred to read the data in a direction from the outer diameter to the inner diameter of the record carrier, as the outer diameter is usually free of cracks. Generally, there is a region of residual stresses at the crack tip that makes crack detection easier. Furthermore, the jumps over the crack that are required to enable reading of the data despite the crack, generally increase gradually from the outer to the inner diameter, which thus facilitates learning.

In a segment on the disc, bounded by cracks, the complete field of track fractions can be read by reversing the read-out direction each time a crack crossing is encountered.

If a crack has been detected, different possibilities exist of how and for which purpose to use this information. For instance, the detection of a crack can be signaled to the user. Furthermore, the read-out velocity can be reduced or the read-out can be stopped, for example in case a crack of a certain length has been detected. If the length and number of cracks is limited, it may be possible to retrieve all data in between the cracks.

The invention will now be explained in more detail with reference to the accompanying drawings, in which

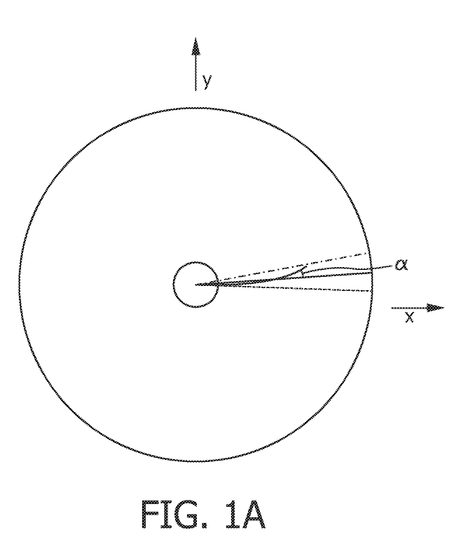

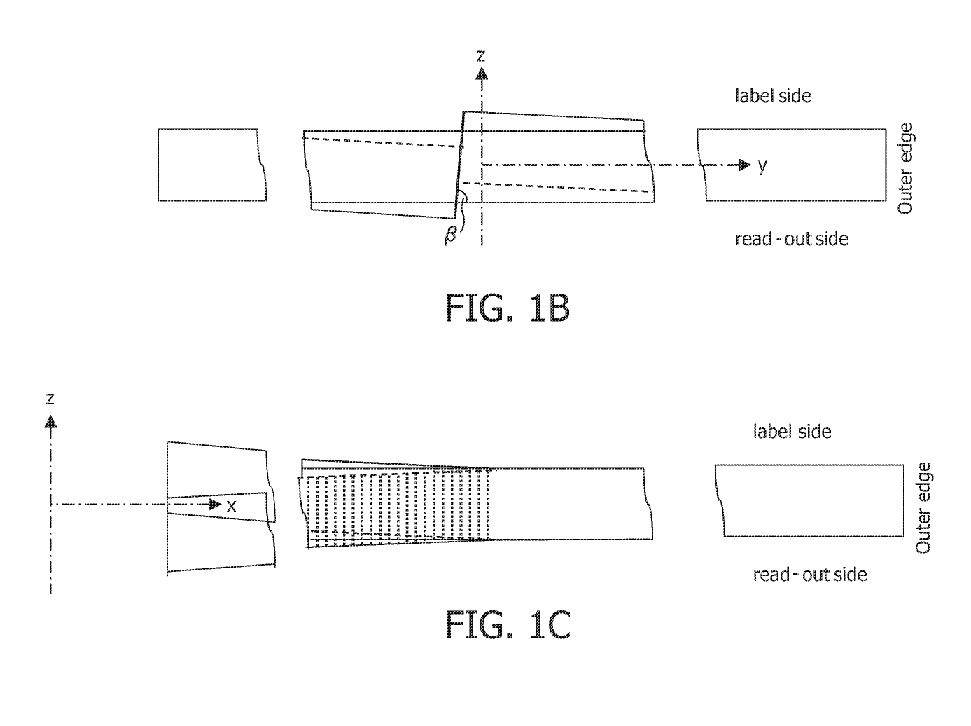

FIG. 1A shows a top view of a record carrier having a typical sharp crack,

FIG. 1B shows a cross sectional view of the same crack in tangential direction,

FIG. 1C shows a cross sectional view of the same crack in radial direction,

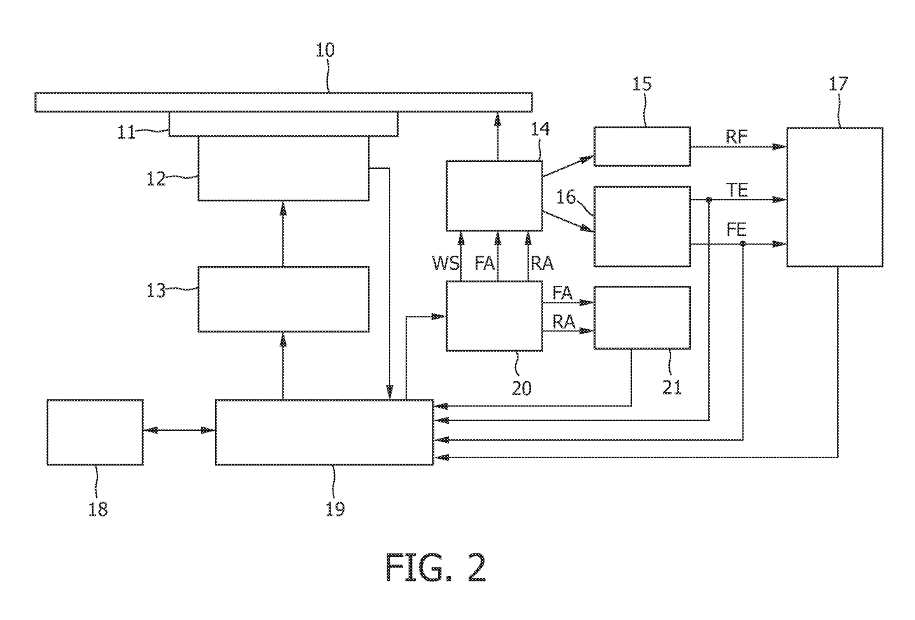

FIG. 2 shows a block diagram of an apparatus according to the present invention,

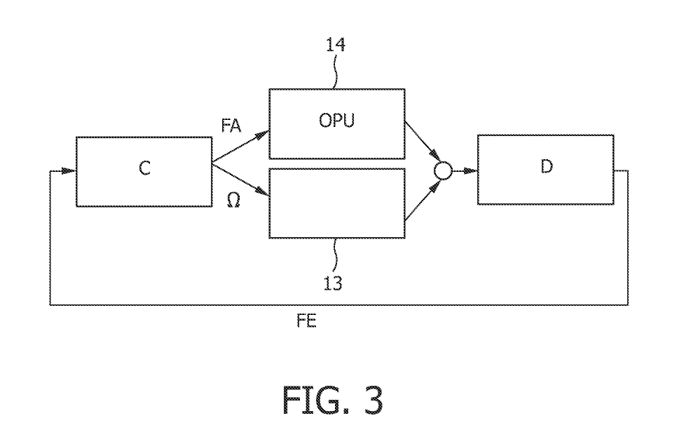

FIG. 3 shows a simplified block diagram illustrating the main idea of the present invention,

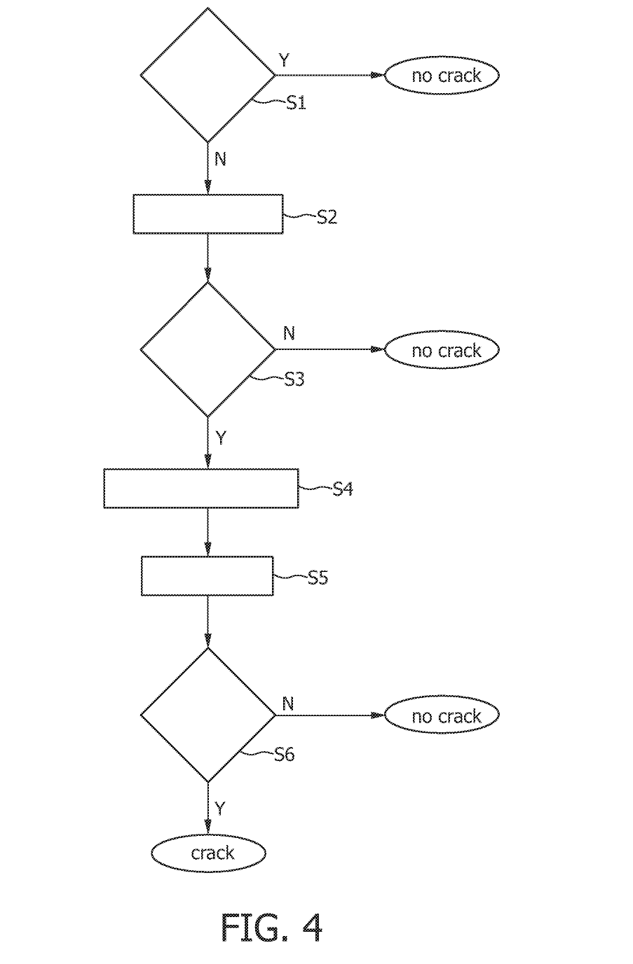

FIG. 4 illustrates the flow chart of a method of crack detection according to the present invention,

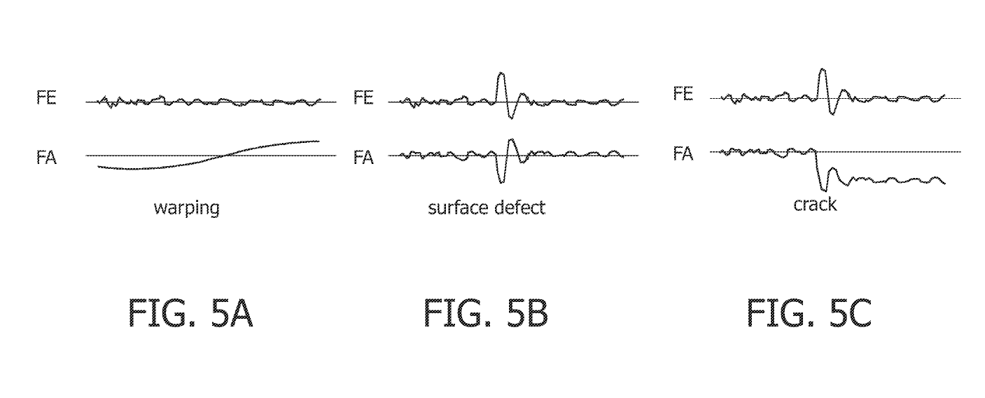

FIGS. 5A, 5B and 5C illustrate typical focus error signals and focus control signals for a warped disc, a disc having a surface defect and a cracked disc, respectively, and

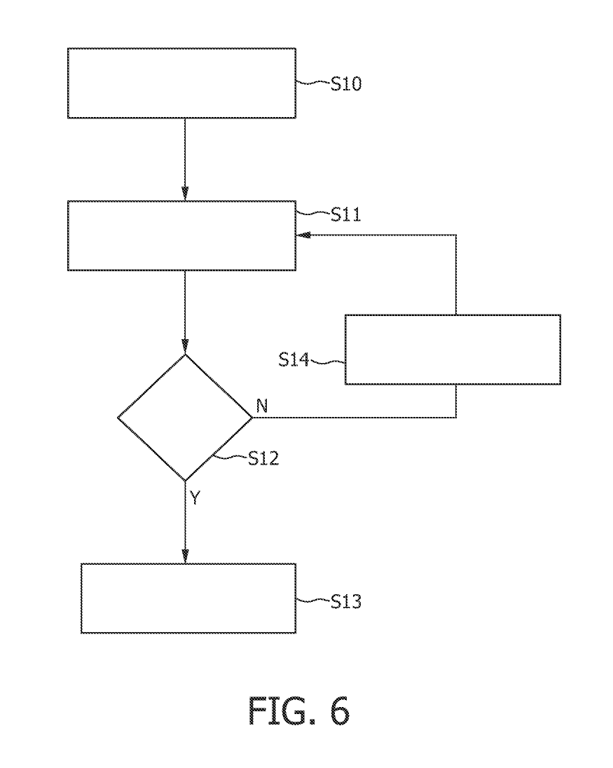

FIG. 6 illustrates the flow chart of a method of reading data from a cracked disc according to the present invention.

Before explaining the present invention, crack-formation in polycarbonate discs will be discussed in more detail. Cracks most likely originate in an area near the hole in the middle of disc shaped record carriers. Older discs regularly show masses of crazes in this area. Mechanical stress due to bending and tension (also occurring in high-speed drives) can exceed a limit at which a single crack develops into a very sharp crack. A typical crack-defected disc thus shows a limited number of sharp cracks with predominantly radial orientation, as is shown in FIG. 1A. FIG. 1B shows a cross-section of the same crack in a tangential direction y, while FIG. 1C shows a cross-section of the same crack in a radial direction x.

A typical crack can be characterized as follows: —the crack is sharp, having two mirror-like edges (see FIG. 1A); —the angle (α in FIG. 1A) of the crack with the radius is limited (in the order of magnitude of 10 degrees); —the orientation of the crack surface with respect to the disc surface (angle β in FIG. 1B) is almost perpendicular (in the order of magnitude of 10 degrees); —the relative displacement and rotation of the crack end is limited such that the overall disc shape is not compromising read-out; —the cracks are not complete, that is, they do not completely extend from the inner to the outer diameter (see FIG. 1C). Of course, other types of cracks exist in practice. The detection method proposed by the present invention can generally detect different types of cracks. However, as far as the present invention deals with the read-out of data from a disc having a crack, the invention will primarily concentrate on the read-out of data from a disc having a typical crack of the kind described above.

FIG. 2 shows a block diagram of an apparatus (such as, for example, an optical disc drive) according to the present invention. This apparatus comprises

a spindle motor 12 for rotating the optical disc 10 disposed on a turntable 11 and a motor driver 13 for controlling the spindle motor 12,

a pick-up 14 for projecting a laser beam (generated, for example, by a laser diode which is not shown in FIG. 2) on the optical disc 10 and for converting an optical signal reflected from the optical disc 10 into an electrical signal,

an RF amplifier 15 for converting the electrical signal (generally an electrical current) and generating a data signal RF,

a servo error detection unit 16 for converting the electrical signal and generating a tracking error signal TE and a focus error signal FE on the basis of the converted signal,

a signal processor 17 for reproducing data recorded in the optical disc 10 on the basis of the RF, TE and FE signals,

a driver 20 for generating a driving current WS for generating the laser beam and for generating a focus actuator signal FA (focus control signal) and a radial actuator signal RA (radial control signal) for controlling the focus position and the radial position of the laser beam on the information layer of the record carrier 10,

a system controller 19 for detecting rotation information of the spindle motor 12 on the basis of a signal outputted by the spindle motor 12 for controlling the motor driver 13 on the basis of the rotation information, so that the spindle motor 12 is driven at a target rotation speed, and for controlling tracking and focusing on the basis of the TE signal and the FE signal outputted from the servo error detection unit 16,

a crack detection unit 21 for determining whether or not there exists a crack on the optical disc 10, and

a memory 18 for storing various programs and data for driving the apparatus.

Hereinafter, an optical disc drive operated according to a method of the present invention will be described. First, the optical disc 10 is loaded on the turntable 11 and rotated at a constant linear velocity (CLV), a constant angular velocity (CAV), or a pseudo constant angular velocity (PCAV) by the spindle motor 12 under control of the motor driver 13. The pick-up 14, which includes a laser diode for generating a laser beam and a photo detector for detecting reflected laser light, projects a laser beam outputted from the laser diode onto the optical disc, detects the optical signal reflected from the optical disc 10 through the photo detector, converts the optical signal into an electrical signal and applies this electrical signal to the RF amplifier 15 and the servo error detection unit 16 where the data signal RF, the tracking error signal TE and the focus error signal FE are generated. These signals are generally known signals, and thus a further detailed explanation is omitted.

Subsequently, the signal processor 17 reproduces the data recorded on the optical disc 10. This signal processor 17 includes hardware and/or software for performing the demodulation and the error correction processing. The driver 20 generates a driving current under the control of the system controller 19 and applies this driving current to the laser diode of the pick-up 14. The laser diode of the pick-up 14 generates a laser beam in accordance with the applied driving current. The system controller 19 reads the data recorded on the rotating optical disc through the pick-up 14, the RF amplifier 15 and the signal processor 17. At the same time, the spindle motor 12 outputs a signal synchronized with the rotation of the spindle motor 12 to the system controller 19. The system controller 19 detects rotation information of the spindle motor 12 on the basis of this signal, controls the spindle motor 12 through the motor driver 13, so that the spindle motor 12 is rotated at a target rotation speed on the basis of the rotation information, and controls tracking and focusing of the optical disc 10 on the basis of the tracking error signal (TE) and the focus error signal (FE) outputted from the servo error detection unit 16. In addition, the crack detection unit 21 determines whether or not the optical disc 10 has a crack. If the optical disc 10 has a crack, the system controller 19 stops the spindle motor 12 through the motor driver 13 or, alternatively, reduces the rotation speed. Moreover, the system controller 19 may signal the detection of a crack to a user.

In case data has to be recovered for a disc on which a crack was detected, a reverse reading and/or stepping can be applied to detect the extension of the crack (crack tip in radial direction). All data recorded at a radius outside the crack tip can be read in a normal way and by normal tracking. The amount of data that can be recovered in this way depends on the data structure of the disc. For example, for discs with the table of contents located exclusively at the inner radius, probably less data can be recovered than for a multi-session disc.

FIG. 3 depicts a simplified and generalized diagram showing only the basic elements of an embodiment according to the invention. The focus error signal FE is detected by a detector D (the servo error detection unit 16 in the embodiment of FIG. 2). This FE signal is provided to a controller C (the system controller 19 in the embodiment of FIG. 2), which generates a control signal Ω for controlling the rotation speed of the disc via the motor driver 13 and which generates the focus control signal FA for focus control via the optical pick-up (OPU) 14.

The distance between the axial (focus) position of the actuated lens in the OPU 14 and the disc 10 is of primary importance for crack detection. However, this distance cannot be measured directly, but can only be deduced from the FE signal. The FA signal is generated by the controller, and as such is known. Using these two signals, FE and FA, the detection of cracks in optical discs is made possible.

A way in which a crack is detected according to the present invention will now be explained with reference to FIG. 4 showing a flowchart of this method. The servo error detection unit 16 is capable of detecting defects on the substrate's outer surface of the disc. The defect at the outer surface due to a typical sharp crack is limited. When such a surface defect is detected, it is checked (in step S1) whether the data signal RF is still intact, that is, whether it shows interruptions or not. This can be constantly monitored. It is noted that ‘intact’ may be interpreted as the delivery of raw data by the read-out system without servo problems being encountered. In other words, there is no reason to believe the raw data is incorrect.

Subsequently, the focus error signal FE is taken and the focus actuator signal (control signal) FA is generated by the drive unit 20 (in step S2). The actual levels of these signals, FE and FA, are compared (in step S3) with their levels just before the defect to find out if they indicated the presence of a typical crack. If the level of the FE signal shows a typical impulse response-like effect and if the FA signal shows a consistent step response-like effect there is reason to believe that a crack transition has been detected. Preferably, this is confirmed by checking over multiple revolutions.

In a further embodiment of the method, the HF data, normally read in between the interrupts, is additionally used (in step S4) to provide chronological or address information, such as ATIP/ADIP information, to compute (in step S5) the number of revolutions of the spiral track skipped during track recovery. If this number exceeds a certain level (in step S6) it can be concluded that a crack has been encountered.

It should be noted that any warping in a disc also contributes to a slowly varying focus control signal over one revolution. A dislocated crack can be viewed as a special case where the level of the focus control signal exhibits an (almost) linearly decreasing or increasing part over one revolution, completed by a sharp jump back to the starting level in the crack zone.

FIG. 5 shows typical FE and FA signals for a warped (but not cracked) disc (FIG. 5A), a disc having a surface defect (but no crack) (FIG. 5B), and a disc having a typical crack as described above (FIG. 5C). The FE signals shown in FIGS. 5B and 5C both exhibit a typical impulse response-like effect (that is, sudden increase and damped oscillation within a short time). Also the FA signals shown in FIGS. 5B and 5C exhibit such an impulse response-like effect. However, only the FA signal for a disc having a crack (shown in FIG. 5C) exhibits a step response-like effect besides the impulse response-like effect. This allows for distinguishing a disc having a surface defect from a disc having a crack. In addition, or as an alternative, to the use of the FE and FA signals, the tracking (radial) error signal TE and the radial control signal RA can be used, for which similar signal patterns occur, although less pronounced.

When checking for effects, in step S3, it should be taken into account that the oscillation period of the impulse-like effect is generally in the order of a few milliseconds, while the total time frame for checking the step-like effect is generally in the order of a few hundred milliseconds. It is further noted that focus steps of more than 5 to 10 μm generally result in loss of focusing, while for tracking a 1 to 2 μm deviation may generally result in a loss of radial tracking.

After an interruption of the reading of data due to a crack, the data can be read again in a common way until a next interruption due to a crack is encountered (often in the next revolution in the case of a single crack), provided the servo is on track again. The data stream in one revolution is large enough to reconstruct header information or ATIP/ADIP information used to tag the data sequence with chronological markers. When there is suspicion of a crack at a fixed angular position of the disc, the chronological data just before and just after the interruption is preferably compared. When the time lead or lag corresponds to exactly the time of n revolutions, the conclusion is justified that a crack has been encountered with a dislocation of the crack surface in the radial direction having a length of n times the track pitch (plus or minus half a track pitch). The more crack transitions are detected with the same time lead or lag of ±n in subsequent revolutions, the higher the likelihood that indeed a crack with a radial track dislocation of ±n in has been detected.

Next, the prediction of servo jumps at the location of a crack transition, allowing reading of, at least part of, the data from a cracked disc, will be discussed with reference to FIG. 6. The crack transition is a zone in which tracking data is basically missing. This is partly due to the fact that the two opposing crack surfaces make a gap, and partly due to the fact that the edges of the crack are damaged. Nevertheless, the data around the crack transition can still be read.

If a crack has been detected, some part of the read data may be incorrect. The crack detection algorithm is preferably designed to provide detailed data on the required jumps (step S10). Because some track fractions may not have been read in the track recovery used during crack detection, it may be needed to jump back a known number of track transitions and start reading again, but now with full feed-forward control (step S11). It is checked (step S12) whether the data read from the track fractions is in the right chronological order (consecutive data). If so, the correction algorithm is finished, and reading the cracked zone can be continued (step S13). If not, it provides additional information on the jumps to be performed, and a kind of learning scheme is implemented (step S14) to converge to servo signals, that pushes the actuator directly to the right position.

A more detailed description will be given herein below.

During crack detection, a number n is determined. For a non-dislocated crack the value for n is zero. In this case no extra tracking action is required to get the data from the disc in the right chronological order. In case n is non-zero, a jump of the objective lens is required in order to be able to recover the correct track. The length of the jump in radial direction equals n multiplied by the estimated track pitch. This track pitch can be estimated reasonably accurately in state-of-the-art drives. The principle used for this purpose is to make two jumps of a certain distance over, respectively, N, M tracks and to read the ATIP/ADIP addresses. This yields two equations from which both the track pitch and the linear velocity can be computed. The jump in focus direction is also estimated in the crack detection part. Now that these actuator jumps have been found, they can be applied at the next revolution; if the crack satisfies the typical sharp-crack definition described earlier, it is very likely that applying these jumps in an open-loop sense (no reliable error signal can be obtained in the crack) sets the read-out spot on the right track part. The data can then be read directly in the correct original chronological order.

The open-loop feed forward control is only used during a crack transition. As soon as the read-out spot is back on track the apparatus is switched to feedback control. For a general understanding, the servo principle for staying on track is an (immediate) feedback of error signals in a so-called closed-loop setting. Such a closed-loop control strives to small errors. In case there are no reliable error signals, feedback is disabled in most applications. This is a typical case where it is better to actively steer the objective lens in the crack crossing phase to maximize the chance of recovering the right track part. In the case of ‘blind track recovery’, a track is found after crossing the crack without active control (neither feedback, nor feed forward). However, there is no guarantee in feed forward control that the right track continuation is found; retries may be necessary. This is part of the learning phase. For example, when a complete revolution is read twice in a row, it is known that at the crack crossing a track has been jumped back. If this were left uncorrected, the same track part would be read over and over again. On the other hand, if the jump is made too far, part of the track will be skipped and will never be read.

As mentioned above, the data part read directly after a crack crossing contains information about the absolute time that can be used to put all the read data parts in the right chronological order. It is noted that the length of an uncorrupted data part required to extract time information is typically some ten millimeters. Each track part should therefore be larger than this minimum length.

It is noted that the present invention is based on the observation that a crack can be detected by combining the information from the servo system. Like scratches and black dots, cracks will lead to error signals with a clear one-cycle signature, but only cracks will show a sudden step-like change in the actuator control signals. Further, it has been recognized that the servo system can be programmed to anticipate the track discontinuity, by using information gathered during the previous jump over the crack.

1. Apparatus for reading data from and detecting a crack in an optical record carrier (10) comprising:
a reading unit (14, 15) for reading data from said record carrier by use of a radiation beam, and for generating a data signal (RF),
a servo error detection unit (16) for tracking a data track along which said data are recorded on the optical record carrier, and for generating a tracking error signal (TE) and a focus error signal (FE),
a control unit (19) for controlling the axial and the radial position of a read-out spot of said radiation beam on said optical record carrier by use of a focus control signal (FA) and a radial control signal (RA), and
a crack detection unit (21) for determining whether there is a crack in said optical record carrier by checking
a) whether said focus error signal (FE) and/or said tracking error signal (TE) show a significant peak, and
b) whether said focus control signal (FA) and/or said radial control signal (RA) show a significant step change.

2. An apparatus as claimed in claim 1, wherein said crack detection unit (21) is adapted for checking whether the amplitude of said focus control signal (FA) is indicative of a change of at least 5 μm and/or whether the amplitude of said tracking error signal (TE) is indicative of a change of at least 1 μm.

3. An apparatus as claimed in claim 1, wherein said crack detection unit (21) is further operative for checking whether the data signal (RF) shows interruptions.

4. An apparatus as claimed in claim 1, wherein said crack detection unit (21) is adapted for comparing the signals used for detecting a crack in the optical record carrier to the corresponding signals previously measured from optical record carriers having a crack, a scratch and/or no mechanical defects.

5. An apparatus as claimed in claim 1, wherein said crack detection unit (21) is adapted for checking the signals used for detecting a crack in the optical record carrier over more than one revolution and/or over at least two neighboring tracks.

6. An apparatus as claimed in claim 1, further comprising
a data processing unit (17) for retrieving address and/or chronological information from the data signal (RF) read in between interruptions, for determining a track skip number indicating the number of revolutions of the track skipped during an interruption, wherein said crack detection unit (21) is adapted for checking whether said track skip number exceeds a predetermined threshold number.

7. An apparatus as claimed in claim 6, wherein the control unit (19) is adapted for using said track skip number for controlling the axial and the radial position of the read-out spot just after a crack.

8. An apparatus as claimed in claim 7, wherein the data processing unit (17) is adapted for retrieving address and/or chronological information from the data signal (RF) read just before and just after a crack, and for checking whether the read address and/or chronological information just before and just after the crack is in the correct sequential or chronological order.

9. An apparatus, as claimed in claim 8, having a feed-forward loop between the control unit (19) and the data processing unit (17) enabling a correction of the axial and of the radial position of the read-out spot just after a crack, if the address and/or chronological information just before and after the crack are not in the right sequential or chronological order, based on the address and/or chronological information retrieved from the data signal read just before and just after the crack when the address and/or chronological information just before and just after the crack are not in the correct sequential or chronological order.

10. An apparatus as claimed in claim 1, further comprising
means (19) for signaling the detection of a crack, and for reducing the read-out velocity and/or stopping the read-out in case a crack has been detected.

11. An apparatus as claimed in claim 1, wherein said control unit (19) is adapted for controlling the radial position of the read-out spot on the record carrier, such that the data are read in a direction from the outer diameter to the inner diameter of the record carrier.

12. An apparatus as claimed in claim 1, wherein said control unit (19) is adapted for controlling the radial position of the read-out spot on said record carrier, such that the read-out direction is reversed each time a crack crossing is encountered.

13. Method of reading data from and detecting a crack in an optical record carrier (10) comprising the steps of:
reading data from said record carrier by use of an irradiation beam, and generating a data signal (RF),
tracking a data track along which said data are recorded on the optical record carrier and generating a tracking error signal (TE) and a focus error signal (FE),
controlling the axial and the radial position of a read-out spot of said radiation beam on said optical record carrier by use of a focus control signal (FA) and a radial control signal (RA), and
determining whether there is a crack in said optical record carrier by checking
a) whether said focus error signal (FE) and/or said tracking error signal (TE) show a significant peak, and
b) whether said focus control signal (FA) and/or said radial control signal (RA) show a significant step change.

14. Computer program comprising program code means for performing the following steps when said computer program is executed by an apparatus comprising a reading unit for reading data from an optical record carrier (10) by use of a radiation beam and for generating a data signal (RF):
tracking a data track along which data are recorded on the optical record carrier and generating a tracking error signal (TE) and a focus error signal (FE),
controlling the axial and the radial position of a read-out spot of said radiation beam on said optical record carrier by use of a focus control signal (FA) and a radial control signal (RA), and
determining whether there is a crack in said optical record carrier by checking
a) whether said focus error signal (FE) and/or said tracking error signal (TE) show a significant peak, and
b) whether said focus control signal (FA) and/or said radial control signal (RA) show a significant step change.

15. A crack detection unit for use in an apparatus for reading data from an optical record carrier operative for
receiving a focus error signal (FE) and/or tracking error signal (TE) and a focus control signal (FA) and/or a radial control signal (RA), and for
determining if there is a crack in said optical record carrier by checking
a) if the focus error signal (FE) and/or the tracking error signal (TE) shows a significant peak, and
b) if the focus control signal (FA) and/or the radial control signal (RA) shows a significant step change.
